(19) United States
(12) Patent Application Publication
(10) Pub. No.: US 2026/0355743 A1
(43) Pub. Date: Nov. 12, 2026

(54) Microfluidic Cooling System

(71) Applicant: IMEC VZW, Leuven (BE)

(72) Inventors: Koen Johannes Hubertus Gerardus de Wijs, Wilsele (BE); Chengxun Liu, Heverlee (BE)

(21) Appl. No.: 19/465,196

(22) Filed: Jan. 30, 2026

(30) Foreign Application Priority Data
Jan. 31, 2025 (EP) 25155225.3

(51) Int. Cl. B01L 3/00

(52) U.S. Cl. CPC B01L 3/502761; B01L 3/502707; B01L 3/502715; B01L 2300/042; B01L 2300/12; B01L 2300/1805; B01L 2300/1894; B01L 2400/0442

(57) ABSTRACT

A microfluidic device comprising: a monolithic semiconductor substrate with thermal conductivity ks; one or more heaters on its top surface, each with a heating element; a thermal insulation layer between the heaters and the substrate, with thermal conductivity ki at least 50 times smaller than ks; and one or more liquid cooling units (30) with cooling fins on the substrate's bottom surface. Each fin has an extremity within 100 μm of a heating element. A cover encloses the cooling units, forming cooling channels and including inlet and outlet ports for liquid circulation.

### CROSS-REFERENCE TO RELATED APPLICATIONS

The present application is a non-provisional patent application claiming priority to international application No. EP 25155225.3, filed on Jan. 31, 2025, the contents of which are hereby incorporated by reference.

### FIELD OF THE DISCLOSURE

The present disclosure relates to the field of microfluidic devices, and more specifically to microfluidic systems for cell sorting.

### BACKGROUND

Microfluidic devices have become indispensable in various biological and chemical applications, such as chemical and biochemical synthesis or in the manipulation and sorting of cells. Techniques employing heating elements within microfluidic channels are utilized to create localized thermal effects, such as triggering a reaction, lysing a cell, or generating vapor bubbles which can actuate fluids and influence the movement of particles or cells.

The integration of heating elements into microfluidic systems introduces challenges related to thermal management. Heat generated during operation can accumulate in the device, leading to elevated temperatures in the surrounding materials and fluids. This heat buildup can affect the performance and reliability of the device. For instance, in cell sorting applications, heat buildup can potentially cause variations in the behavior of vapor bubbles and alter fluid dynamics within the channels.

Thermal accumulation can also impose limitations on the operational speed of microfluidic devices. Excess residual heat may restrict the frequency at which heating elements can be activated without compromising device stability. As a result, the maximum achievable rates for processes like cell sorting may be constrained, which is a concern in applications requiring high throughput.

In applications such as cell sorting, variability in cell arrival rates and the random nature of cell distribution within microfluidic channels can further complicate thermal management. Fluctuating operational demands on the heating elements can lead to inconsistent thermal conditions, impacting the uniformity and predictability of device operation.

Efforts to dissipate excess heat have explored various cooling methods within microfluidic systems. However, some existing cooling solutions demand substantial space within the device architecture. The need for larger areas to accommodate cooling components can hinder the miniaturization of devices and limit the integration of multiple functional units on a single chip. This spatial constraint poses challenges for scaling up microfluidic systems to achieve parallel processing and higher throughput.

Manufacturing considerations also play a significant role in the design of microfluidic devices with integrated heating and cooling functionalities. Integrating electrical connections, fluidic pathways, and thermal management features into a compact form factor requires careful planning. Balancing these elements without increasing the device footprint or complicating fabrication processes remains a complex issue in the field.

Despite advancements in microfluidic technology, there is still a need for further developments to overcome at least some of these challenges.

### SUMMARY

The present disclosure provides microfluidic devices and methods for their manufacturing.

In a first embodiment, disclosure relates to a microfluidic device comprising a monolithic semiconductor substrate having a thermal conductivity ks, one or more heaters disposed over a top surface of the monolithic semiconductor substrate, each heater comprising a heating element, a thermal insulation layer disposed between the one or more heaters and the substrate, wherein the thermal insulation layer has a thermal conductivity ki at least 50 times smaller than the thermal conductivity ks of the monolithic substrate, one or more liquid cooling units, each liquid cooling unit comprising a plurality of cooling fins formed in a bottom surface of the monolithic semiconductor substrate, each cooling fin having an extremity separated by a distance (d) of at most 100 μm from one of the heating elements, and a cover attached to the bottom of the monolithic semiconductor substrate and closing the one or more liquid cooling units, wherein the cover is configured to cover the cooling fins, thereby forming enclosed cooling channels between the cover and the monolithic semiconductor substrate, and the cover includes one or more inlet ports and one or more outlet ports connected to the cooling channels to allow circulation of a cooling liquid through the cooling channels.

In embodiments, the one or more heaters may be disposed over a top surface of the monolithic semiconductor substrate without another semiconductor substrate between the one or more heaters and the monolithic semiconductor substrate.

In embodiments, the one or more heaters may be in direct contact with a top surface of the thermal insulation layer.

In embodiments, the one or more heaters may be formed directly on a top surface of the thermal insulation layer.

These embodiments minimize the distance between the heaters and the thermal insulation layer.

In embodiments, the distance (d) may be from 25 to 75 μm. For example, the distance (d) in some embodiments may be from 35 to 65 μm. Having the cooling fins extremely close to the heater (e.g., within 25-100 μm) dramatically shortens the heat conduction path so that the heat generated by the resistor is siphoned away more efficiently and quickly. For instance, when the microfluidic device is a cell sorting device, this tighter thermal link between the heater and the cooling fins allows higher repetition rates (e.g., faster bubble generation for cell sorting) and keeps the base temperature of the heater from drifting too high. In other words, being very close makes the cooling far more effective.

A minimal distance of 25 μm provides mechanical stability.

In embodiments, the microfluidic device may further comprise a further semiconductor substrate attached over the monolithic semiconductor substrate, and at least one first fluidic channel formed in the further semiconductor substrate, each first fluidic channel being thermally coupled to at least one heater so that the heater is capable of locally heating the content of the first fluidic channel. This allows for precise temperature control of the liquid in the first fluidic channel.

In embodiments, the at least one first fluidic channel may have a height measured perpendicularly to a top surface of the thermal insulation layer of from 20 to 100 μm. This provides a channel size suitable for many microfluidic applications.

In embodiments, the microfluidic device may further comprise a transparent substrate on top of the further semiconductor substrate and closing the first fluidic channel. This allows for optical access to the first fluidic channel.

In embodiments, the transparent substrate may have a thickness of from 500 to 725 μm. This provides mechanical robustness while still allowing optical access.

In embodiments, the microfluidic device may further comprise integrated optics formed in the transparent substrate for illumination and/or optical scatter light collection. This enables on-chip optical analysis.

In embodiments, the substrate may comprise silicon. Silicon provides high thermal conductivity for efficient heat dissipation.

In embodiments, the thermal insulation layer may comprise silicon dioxide. Silicon dioxide provides effective thermal insulation.

In embodiments, the thickness t of the thermal insulation layer may satisfy the equation 200 nm*(ki/1.4 W/mK)≤t≤3000 nm*(ki/1.4 W/mK), wherein ki is expressed in W/mK. This provides an effective insulation layer thickness.

In embodiments, the cooling fins may have a depth between 100 μm and 200 μm. This allows for efficient heat transfer to the cooling fluid.

In embodiments, the cooling fins may have a width of from 10 μm to 100 μm. This provides a balance between heat transfer, surface area and manufacturability.

In embodiments, the cooling fins may be spaced apart by a distance of from 10 μm to 100 μm. This allows for efficient flow of the cooling liquid between the fins.

In embodiments, the cover may comprise an electrically non-conductive material. This prevents electrical shorting of the device components.

In embodiments, the cover may comprise a material having a thermal conductivity lower than 0.5 W/m·K. This minimizes parasitic heat loss through the cover.

In embodiments, the cover may comprise polydimethylsiloxane (PDMS). PDMS is easy to mold and bond to the substrate.

In embodiments, the device may be configured to perform PCR, to lyse biological cells, to serve as an array of microreactors, or to sort biological cells, amongst others.

In some embodiments, the device may be configured for sorting particles such as biological cells, wherein the at least one first fluidic channel is a bubble channel, wherein the bubble channel is thermally coupled to the at least one heater so that the heater is capable of locally heating the content of the first fluidic channel to locally generate bubbles and direct them toward a second channel, said second channel (which can be called the “main channel”) being for allowing the passage of the particles and being fluidically connected to the first fluidic channel, wherein the device further comprises a third fluidic channel fluidically connected to the second fluidic channel, thereby providing a pathway where the particles can be diverted. This allows for controlled displacement of particles from the second channel to the third channel. And this allows the device to be used for high-throughput cell sorting.

In embodiments, each heater may be positioned laterally beside or below one of said first fluidic channels. This configuration provides efficient heating and, for instance, efficient bubble generation for cell sorting.

Each heater comprises a heating element.

In embodiments, each heating element may be formed in physical contact with the thermal insulation layer so that the thermal insulation layer is the only layer separating the heating element from the liquid cooling unit.

In embodiments, the heating element may be formed of a metal. For instance, it may be formed of W, Ti, TiN, or a combination thereof.

In eom embodiments, the heater may further comprise passivation layers on top of the heating element. Passivation layers may for instance comprise SiN, SiC, Ta, or combinations thereof. For instance, the heater may comprise a W heating element, a SiN layer thereon, an SiC layer on the SiN layer, and a cavitation resistant layer (such as Ta) on the SiC layer. The presence of passivation layers when the heater is in contact with a liquid results in the electrical isolation of these layers the heater from the liquid. When the device is a cell sorter, a cavitation withstanding layer provides a protective layer against the effects of cavitation on the heater. For instance, Ta may be used as a cavitation withstanding layer.

In embodiments, when a second fluidic channel is present, the microfluidic device may further comprise a particle (e.g., cell) detection system configured to detect particles (e.g., cells) passing through the second fluidic channel, enabling timely activation of the heaters for cell sorting. This allows for precise control over the sorting process.

In embodiments, when a second fluidic channel is present, the cell detection system may comprise optical detection components capable of identifying particles (e.g., cells) in the liquid flow of the second fluidic channel. Optical detection enables non-contact sensing of particles (e.g., cells).

In embodiments, the optical detection components may be selected from photodiodes, fluorescence detectors, or optical sensors. These are well-established optical detection technologies.

In embodiments, the microfluidic device may further comprise a control unit configured to receive signals from the particle (e.g., cell) detection system and selectively activate the heating elements of the heaters to generate vapor bubbles that divert detected particles (e.g., cells) into the third fluidic channel. This provides automated control over the particle (e.g., cell) sorting process.

In embodiments, the monolithic substrate may have a thickness between 100 μm and 300 μm with the proviso that said thickness is larger than the depth of the cooling fins. This provides mechanical stability while allowing room for the cooling fins.

In embodiments, the microfluidic device may further comprise via openings for forming electrical connections, said openings having a width larger than the width of a trench between two cooling fins, crossing the entire thickness of the monolithic substrate. This allows for convenient electrical interfacing to the device.

In embodiments, the microfluidic device may further comprise integrated optics formed in the monolithic substrate for illumination and/or light collection such as optical scatter light collection. This enables additional on-chip optical functionality.

In embodiments, the device may further comprise the further semiconductor substrate and a transparent substrate on top of the further semiconductor substrate and closing the first fluidic channel, and optionally the second and third fluidic channels when they are present, and wherein the device comprises integrated optics in both the monolithic semiconductor substrate and in the transparent substrate, wherein the integrated optics in the transparent substrate is for illumination and the integrated optics in the monolithic semiconductor substrate is for light collection such as optical scatter light collection, or vice versa. This configuration allows for comprehensive on-chip optical analysis.

In embodiments, for each cooling unit and its associated heater, the planar area occupied by the cooling fins in the cooling unit may be between 80% and 120% of the planar area of the heating element of the associated heater. The planar area occupied by the cooling fins may be measured as the area of the substrate surface taken up by the fins when viewed perpendicular to the substrate surface, including both the area of the fin tops and the area between the fins, and the planar area of the heating element may be measured as the area of the heating element when viewed perpendicular to the substrate surface. This ensures the cooling capacity is well-matched to the heating power.

Any feature of this embodiment may be as correspondingly described in any other embodiments.

In a second embodiment, the present invention relates to a method of manufacturing a microfluidic device, the method comprising (i) providing a monolithic semiconductor substrate having a thermal conductivity ks, (ii) forming a thermal insulation layer over a top surface of the substrate, wherein the thermal insulation layer has a thermal conductivity ki at least 50 times smaller than the thermal conductivity ks of the monolithic substrate, (iii) forming one or more heaters over the thermal insulation layer, each heater comprising a heating element, (iv) etching a bottom surface of the monolithic substrate to form a plurality of cooling fins for one or more cooling units, each cooling fin having an extremity separated by a distance (d) of at most 100 μm from one of the heating elements, and (v) providing a cover attached to the monolithic substrate so as to close the one or more liquid cooling units, thereby forming enclosed cooling channels between the cover and the substrate wherein the cover includes one or more inlet ports and one or more outlet ports connected to the cooling channels to allow circulation of a cooling liquid through the cooling channels.

In embodiments, the method further comprises a step (iiib) of bonding the further semiconductor substrate over the heater. In embodiments, the further semiconductor comprises at least one first fluidic channel (e.g., a bubble channel), optionally comprises at least a second fluidic channel (e.g., a main channel) fluidically connected to one of the first fluidic channels. When it comprises at least a second fluidic channel, it may additionally comprise at least a third fluidic channel fluidically connected to one of the second fluidic channels.

In embodiments, step (iv) of etching the bottom surface of the substrate may be performed in a single bottom etching step to simultaneously form the cooling fins and partially form the fluidic via openings for coupling with at least one first fluidic channel (e.g., by the intermediary of a direct fluidic connection with a second (main) channel). This simplifies the manufacturing process.

In embodiments, the cooling fins may be separated by trenches having a width between 10 μm and 100 μm. This allows for efficient flow of the cooling liquid between the fins.

In embodiments, the cooling fins may have a fin width between 10 μm and 100 μm. This provides a balance between heat transfer surface area and manufacturability.

In embodiments, the cooling fins may be etched to a depth that leaves a portion of the substrate unetched between the cooling fin trenches and the thermal insulation layer. This provides mechanical stability.

In embodiments, the single bottom etching step may be a dry etching step that, in addition to forming cooling fins separated by trenches of width W by etching to a depth that leaves a portion of the substrate unetched, also simultaneously forms via openings for electrical connections, said via openings having a width larger than W, by etching entirely through the bottom surface of the substrate. This further simplifies the manufacturing process.

In embodiments, the fluidic via openings may be etched during the single bottom etching step to a depth that leaves a portion of the substrate unetched between each fluidic via opening and the thermal insulation layer, and wherein the method further comprises removing (ivc) said portion by etching it from the top surface of the monolithic substrate.

In embodiments, the monolithic substrate may be thinned to a thickness between 100 μm and 300 μm prior to the etching step. This reduces the amount of etching needed to form the cooling fins.

In embodiments, the cooling fins may be etched to a depth between 100 μm and 200 μm. This allows for efficient heat transfer to the cooling fluid.

In embodiments, the method may further comprise integrating optics in the monolithic substrate for illumination and/or optical scatter light collection and/or optical fluorescence light collection. This enables on-chip optical analysis.

In embodiments, the method may further comprise attaching a further semiconductor substrate over the top surface of the monolithic semiconductor substrate, and forming at least one first fluidic channel in the further semiconductor substrate, each first fluidic channel being thermally coupled to at least one heater so that the heater is capable of locally heating the content of the first fluidic channel. This allows for precise temperature control of the liquid in the first channel.

In embodiments, the method may further comprise closing the (top of the) first fluidic channel by attaching a transparent substrate on top of the further semiconductor substrate. This allows for optical access to the first channel.

In embodiments, the method may further comprise integrating optics in the transparent substrate for illumination and/or optical scatter light collection and/or optical fluorescence light collection. This enables additional on-chip optical functionality.

Any feature of this embodiment may be as correspondingly described in any other disclosed embodiments.

The present disclosure offers effective removal of heat buildup in and around the heater can be achieved. For instance, when the device is configured for sorting biological cells, this increases the maximum achievable cell sorting rate.

The present disclosure realizes a reduction in temperature fluctuations at the heater. For instance, when the device is configured for sorting biological cells, this results in more consistent jet power for sorting, which helps cope with variations in cell rates and the random arrival of cells.

The present disclosure enables the effective removal of heat with a low footprint cooling system. For instance, when the device is configured for sorting biological cells, this allows parallel sorting at high rates on a single die.

The present disclosure enables combining the etching of cooling trenches, fluidic backside connections, and electrical connections all from the bottom side of the monolithic substrate, a small footprint of the device is realized and is compatible with mass production.

The present disclosure allows for compatibility with integrated optics, allowing for the inclusion of optical detection components and enhancing functionality.

The present disclosure allows for precise temperature control in biological and chemical reactions is permitted due to the effective heat dissipation and temperature regulation.

The present disclosure provides for the cooling system incorporating smaller dimensions and a closer proximity of cooling to the heat source, resulting in more localized cooling compared to existing solutions.

The present disclosure provides an integrated design, as opposed to separate cooling components, enhancing efficiency and reducing manufacturing complexity.

The above and other characteristics, features and advantages of the present disclosure will become apparent from the following detailed description, taken in conjunction with the accompanying drawings, which illustrate, by way of example, the principles of the disclosure. This description is given for the sake of example only, without limiting the scope of the claims or subject matter taught. The reference figures quoted below refer to the attached drawings.

### BRIEF DESCRIPTION OF THE DRAWINGS

FIGS. 1 and 2 are cross-sectional views illustrating fabrication steps of a microfluidic device according to embodiments of the present disclosure.

FIG. 3 is a magnified cross-sectional view of the main components of the microfluidic device according to embodiments of the present disclosure.

FIG. 4 is a flow chart exemplifying a manufacturing method according to embodiments of the present disclosure.

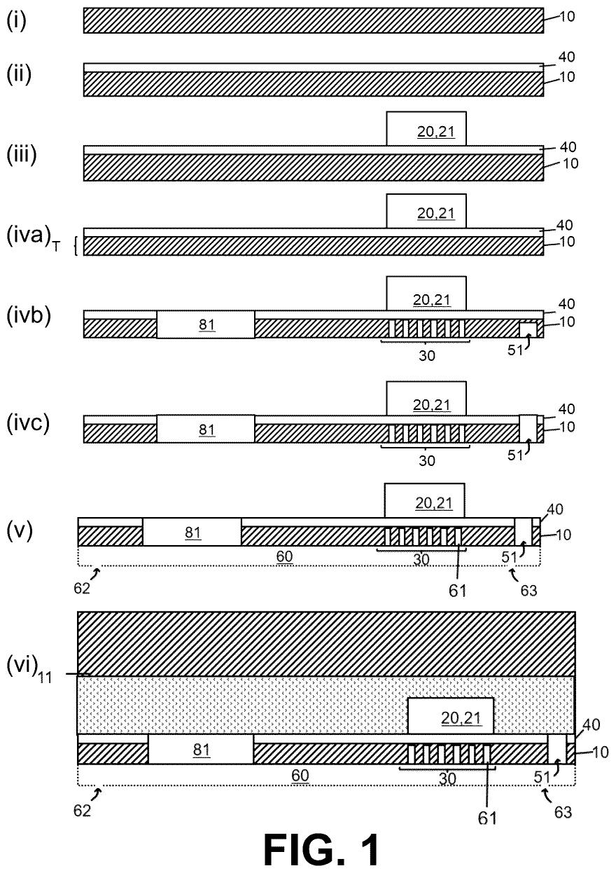

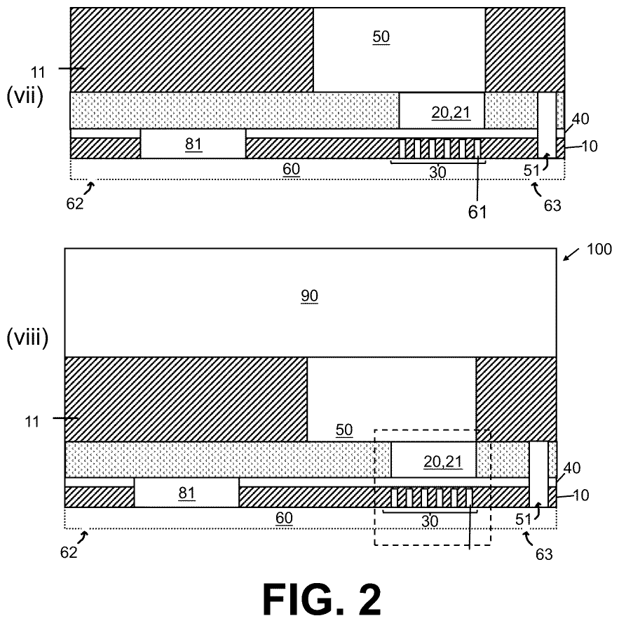

In the different figures, the same reference signs refer to the same or analogous elements.

### DETAILED DESCRIPTION

The present disclosure will be described with respect to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

The following terms are provided solely to aid in the understanding of the disclosure.

As used herein, and unless otherwise specified, the term “monolithic semiconductor substrate” refers to a single, continuous piece of semiconductor material that forms an integrated structure without any intervening layers or discontinuities of semiconductor material, such that the substrate acts as one unified body. Examples of monolithic semiconductor substrates include single-crystal silicon wafers and other uniform semiconductor substrates used in device fabrication.

As used herein, and unless otherwise specified, the phrase “without another semiconductor substrate between” means that there is no additional semiconductor substrate layer interposed directly between the specified components, specifically, there is no other semiconductor material separating the one or more heaters (20) from the monolithic semiconductor substrate (10). For instance, the heaters may be directly on the thermal insulation layer (40) which is on the monolithic semiconductor substrate (10).

As used herein, and unless otherwise specified, the term “heater” refers to a device comprising at least one heating element (21) that generates heat when electrical current is applied, used to locally increase the temperature of adjacent structures or materials within the microfluidic device (100). Examples of heaters include resistive heating elements patterned on a substrate to provide localized heating. In addition to a heating element, a heater may comprise further elements such as, for instance, passivation layers.

As used herein, and unless otherwise specified, the term “heating element” refers to the component within a heater (20) that directly converts electrical energy into thermal energy through resistive or other heating mechanisms. Heating elements may be composed of materials such as metals or doped semiconductors configured to produce heat when an electrical current passes through them.

As used herein, and unless otherwise specified, the term “thermal insulation layer” refers to a layer of material disposed between two components that reduces the transfer of heat between them due to its low thermal conductivity. In the context of the microfluidic device (100), the thermal insulation layer (40) reduces heat flow from the heaters (20) to the monolithic semiconductor substrate (10). An example of a thermal insulation layer is a silicon dioxide layer formed by thermal oxidation or deposition.

As used herein, and unless otherwise specified, the term “thermal conductivity ks” refers to the thermal conductivity of the monolithic semiconductor substrate (10), measured in watts per meter-kelvin (W/m·K), indicating the substrate's ability to conduct heat. For example, silicon substrates have a thermal conductivity ks typically around 148 W/m·K at room temperature.

As used herein, and unless otherwise specified, the term “thermal conductivity ki” refers to the thermal conductivity of the thermal insulation layer (40), measured in watts per meter-kelvin (W/m·K), indicating the insulation layer's ability to conduct heat. For instance, silicon dioxide has a thermal conductivity ki approximately 1.4 W/m·K.

As used herein, and unless otherwise specified, the phrase “ki at least 50 times smaller than ks” means that the thermal conductivity ki of the thermal insulation layer (40) is equal to or less than one-fiftieth (1/50) of the thermal conductivity ks of the monolithic semiconductor substrate (10). This ensures a significant reduction in heat transfer between the heater (20) and the substrate (10).

As used herein, and unless otherwise specified, the term “liquid cooling units” refers to structures within the microfluidic device (100) designed to facilitate the removal of heat through the circulation of a cooling fluid. Each liquid cooling unit (30) includes features such as cooling fins (31) and cooling channels (61) that enhance heat exchange between the device and the cooling fluid. An example of cooling channels includes microfluidic channels between fins to increase surface area for heat dissipation.

As used herein, and unless otherwise specified, the term “plurality of cooling fins” refers to multiple elongated structures formed in a surface, specifically in the bottom surface of the monolithic semiconductor substrate (10), that increase the surface area available for heat transfer within the liquid cooling units (30). The cooling fins (31) are designed to facilitate efficient cooling when a liquid flows over them.

As used herein, and unless otherwise specified, the phrase “formed in a bottom surface” means that the specified structures, such as the cooling fins (31), are created by material removal or addition processes on the lower surface of the monolithic semiconductor substrate (10), opposite the top surface where the heaters (20) are disposed. This formation can be achieved through etching techniques such as deep reactive ion etching (DRIE).

As used herein, and unless otherwise specified, the phrase “extremity separated by a distance (d) of at most 100 μm from one of the heating elements” means that for each cooling fin, there exists an end point at a distance of maximum 100 μm from the nearest point of a heating element (21). This close proximity ensures efficient thermal coupling for effective cooling.

As used herein, and unless otherwise specified, the phrase “attached to the bottom of the monolithic semiconductor substrate” means that the cover (60) is affixed to the lower surface of the monolithic semiconductor substrate (10). Typically, it is performed in a manner that creates a sealed interface, enclosing the liquid cooling units (30). Attachment methods may include adhesive bonding, thermal bonding, or other suitable techniques for securing the cover to the substrate.

As used herein, and unless otherwise specified, the phrase “configured to cover the cooling fins, thereby forming enclosed cooling channels” means that the cover (60) is designed and positioned so that when attached to the monolithic semiconductor substrate (10), it encloses the spaces between the cooling fins (31), resulting in the formation of cooling channels (61) through which cooling liquid can be directed. The configuration ensures that the cooling liquid flows over the surface area of the fins for effective heat exchange.

As used herein, and unless otherwise specified, the expression “allow circulation of a cooling liquid through the cooling channels” means that the design of the cooling channels (61), along with the inlet ports (62) and outlet ports (63), permits the continuous flow of a cooling liquid into, through, and out of the cooling channels, enabling the transfer of heat away from the device during operation. Examples of cooling fluids include water, ethylene glycol mixtures, or other suitable heat-transfer liquids.

As used herein, and unless otherwise specified, the term “main fluidic channel” or “second fluidic channel” refers to a primary microfluidic pathway within the device through which the main flow of fluid, such as a suspension containing biological cells, is directed. The main fluidic channel may interface with other components like first fluidic channel(s), third fluidic channel(s), heaters (20) and detection systems (110) for processing the fluidic content.

As used herein, and unless otherwise specified, the term “third fluidic channel” refers to a secondary microfluidic pathway connected to a main fluidic channel, providing an alternative route for liquid or particles diverted from the main flow. The third fluidic channel allows for processes such as cell sorting or separation of specific components from the main stream.

As used herein, and unless otherwise specified, the term “first fluidic channel” or in some embodiments “bubble fluidic channel” refers to a first microfluidic pathway within the device that is thermally coupled to at least one heater so that the heater is capable of locally heating the content of the first fluidic channel (50). In particle-sorting embodiments, this first fluidic channel is a bubble fluidic channel (50) in which bubbles (e.g., microbubbles) can be generated and directed toward the main fluidic channel. An example of bubble fluidic channel can be found in EP3221049.

As used herein, and unless otherwise specified, the phrase “thermally coupled” means that two components are connected or positioned in such a way that heat can be transferred from one to the other, either through direct contact or via a thermally conductive intermediary. In the device, the heaters (20) are thermally coupled to the first fluidic channels (50) (e.g., the bubble fluidic channel) to facilitate localized heating.

As used herein, and unless otherwise specified, the phrase “capable of locally heating the content of the first fluidic channel” means that the heater (20) is designed to increase the temperature of the liquid or particles within a specific, confined region of the first fluidic channel (50). This localized heating can be used for functions such as inducing vapor bubble formation for particle (e.g., cell) sorting.

As used herein, and unless otherwise specified, the term “biological cells” refers to living cells derived from organisms, including but not limited to animal cells, plant cells, bacterial cells, or fungal cells. The device is configured to manipulate or process such cells within the fluidic channels.

As used herein, and unless otherwise specified, the phrase “fluidic via openings” refers to openings or passages formed through a substrate that allows fluids to move between different layers or regions of the microfluidic device.

As used herein, and unless otherwise specified, the phrase “via openings for forming electrical connections” refers to holes or passages created through the monolithic substrate (10) that enable electrical conductors or pathways to pass through, allowing electrical interconnections between components on opposite sides of the substrate or at different layers of the device.

As used herein, and unless otherwise specified, the term “integrated optics” refers to optical components or systems fabricated within or on the substrates of the device, enabling optical functionalities such as guiding, splitting, or manipulating light. Integrated optics may include waveguides, lenses, photodiodes, or other optical elements incorporated into the monolithic semiconductor substrate (10) or the transparent substrate (90).

As used herein, and unless otherwise specified, the term “particle (e.g., cell) detection system” refers to one or more components within the device that identify the presence or characteristics of particles (e.g., cells) within the main fluidic channel. This system (110) may utilize optical methods such as light scattering, fluorescence detection, or imaging to detect particles (e.g., cells) as they pass through the channel.

As used herein, and unless otherwise specified, the term “control unit” refers to an electronic module or circuitry configured to process signals from sensors like the cell detection system (110) and to control actuators such as the heaters (20). The control unit (120) executes algorithms or instructions to perform functions like timely activation of heaters for cell sorting.

As used herein, and unless otherwise specified, the phrase “timely activation” means engaging or initiating the operation of a component, such as the heaters (20), at a specific time or in response to a particular event to achieve a desired outcome. In cell sorting applications, timely activation ensures that heaters produce vapor bubbles precisely when needed to divert detected cells.

As used herein, and unless otherwise specified, the term “depth (D)” refers to the vertical distance that the cooling fins (31) extend into the monolithic semiconductor substrate (10) from the bottom surface. The depth of the cooling fins affects the surface area available for heat exchange and the proximity to the heating elements (21).

As used herein, and unless otherwise specified, the term “thickness t of the thermal insulation layer (40)” refers to the physical measurement of the thermal insulation layer's (40) width between its two main surfaces, measured perpendicular to the plane of the layer. The thickness t influences the thermal insulation properties between the heaters (20) and the substrate (10).

As used herein, and unless otherwise specified, the term “thickness (T)” refers to the overall vertical dimension of the monolithic semiconductor substrate (10) from its top surface to its bottom surface.

In embodiments, the proviso that the thickness (T) is larger than the depth (D) of the cooling fins (31) ensures that the cooling fins do not extend completely through the substrate (10), maintaining an unetched portion between the top surface and the fins.

As used herein, and unless otherwise specified, the phrase “planar area occupied by the cooling fins is between 80% and 120% of the planar area of the heating element of its associated heater” means that the surface area covered by the cooling fins (31), when viewed from above (perpendicular to the substrate surface), is approximately the same size as the surface area covered by the heating element of the associated heater (20), within a margin of 20% smaller or larger. This ensures adequate cooling relative to the size of the heater.

As used herein, and unless otherwise specified, the term “planar area of the heating element” refers to the two-dimensional surface area that the heating element covers on the plane parallel to the substrate surface, measured when viewed perpendicularly to the substrate. This measurement includes the entire area enclosed by the outer boundaries of the heater.

As used herein, and unless otherwise specified, the phrase “single bottom etching step” refers to an etching process performed on the bottom surface of the monolithic semiconductor substrate (10) in one continuous operation, during which multiple features such as cooling fins (31), trenches (33), fluidic via openings (51), and via openings (81) for electrical connections are simultaneously formed. This method enhances manufacturing efficiency by reducing the number of processing steps.

As used herein, and unless otherwise specified, the term “dry etching step” refers to an etching process that removes material from a substrate using a plasma or vapor-phase etchant rather than a liquid chemical solution. Dry etching techniques, such as reactive ion etching (RIE) or deep reactive ion etching (DRIE), provide precise control over etch profiles and feature dimensions.

The invention will now be described by a detailed description of several embodiments of the invention. It is clear that other embodiments of the invention can be configured according to the knowledge of persons skilled in the art without departing from the technical teaching of the invention, the invention being limited only by the terms of the appended claims.

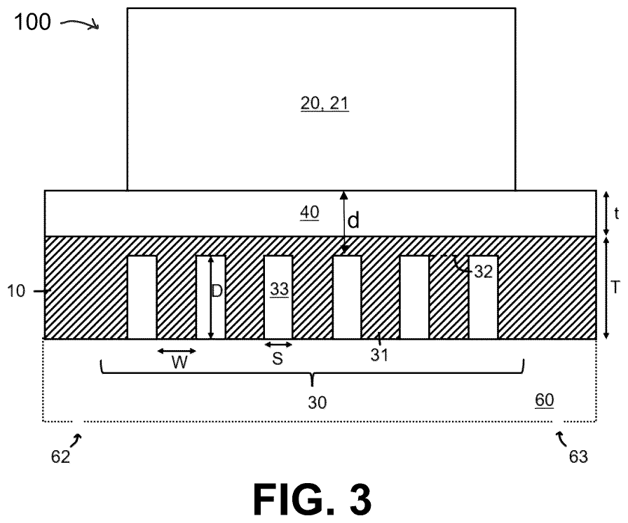

In a first embodiment, as illustrated in FIG. 3, the present disclosure relates to a microfluidic device (100) comprising a monolithic semiconductor substrate (10) with a thermal conductivity ks. One or more heaters (20) are disposed over a top surface of the monolithic semiconductor substrate (10). Each heater (20) comprises a heating element (21). A thermal insulation layer (40) is positioned between the heaters (20) and the substrate (10), where the thermal insulation layer (40) has a thermal conductivity ki that is at least 50 times smaller than the thermal conductivity ks of the monolithic substrate (10).

The device further comprises one or more liquid cooling units (30), each comprising a plurality of cooling fins (31) formed in the bottom surface of the monolithic semiconductor substrate (10). Each cooling fin (31) has an extremity (32) separated by at most 100 μm from one of the heating elements (21). A cover (60) is attached to the bottom of the monolithic semiconductor substrate (10), closing the liquid cooling units (30). The cover (60) is configured to cover the cooling fins (31), forming enclosed cooling channels (61) between the cover (60) and the substrate (10). The cover (60) includes one or more inlet ports (62) and one or more outlet ports (63) connected to the cooling channels (61) to allow circulation of a cooling liquid through the channels.

In embodiments, the one or more heaters (20) may be disposed over a top surface of the monolithic semiconductor substrate (10) without another semiconductor substrate between the one or more heaters (20) and the monolithic semiconductor substrate (10).

In embodiments, the one or more heaters (20) may be in direct contact with a top surface of the thermal insulation layer (40).

In embodiments, the one or more heaters (20) may be formed directly on a top surface of the thermal insulation layer (40).

These embodiments minimize the distance between the heaters (20) and the thermal insulation layer (40).

In embodiments, the microfluidic device (100) may further comprise cooling fins formed directly in the monolithic substrate (10) beneath each heater (20), occupying a planar area slightly larger than that of the heating element of the heater (20). By forming the cooling fins directly beneath the heaters (20) and optimizing their dimensions, the device may allow for multiple heaters (20) to be integrated closely on a single chip, enabling parallel operations and reducing the overall footprint per heater (20). This configuration supports high-throughput applications such as parallel cell sorting.

In embodiments, the microfluidic device (100) may further comprise a further semiconductor substrate (11) attached over the heater (20). At least one first fluidic channel (50) may be formed in the further semiconductor substrate (11), each first fluidic channel (50) being thermally coupled to at least one heater (20) so that the heater (20) is capable of locally heating the contents of the first fluidic channel (50).

The at least one first fluidic channel (50) may have a height measured perpendicularly to the top surface of the thermal insulation layer (40) of from 20 to 100 μm. This provides an optimal channel size for many microfluidic applications.

In embodiments, the device may further comprise a transparent substrate (90) on top of the further semiconductor substrate (11), closing the first fluidic channel (50). This allows for optical access to the first channel. The transparent substrate (90) may have a thickness of from 500 to 725 μm, providing mechanical robustness while still allowing optical access.

In embodiments, optical components may be integrated on both the top transparent substrate (90) and the bottom monolithic semiconductor substrate (10), enhancing the optical detection capabilities of the device. The integrated optics in the transparent substrate (90) may include optical waveguides and components for illuminating biological samples within the fluidic channels, while the monolithic substrate (10) may contain integrated optical detectors or waveguides for collecting light from the samples. This dual integration of optical components provides enhanced detection sensitivity and functionality without increasing the device footprint.

The substrate (10) may comprise silicon, which provides high thermal conductivity for efficient heat dissipation. The thermal insulation layer (40) may comprise silicon dioxide, offering excellent thermal insulation.

The thickness t of the thermal insulation layer (40) may satisfy the equation:

200 nm*(ki/1.4 W/mK)≤t≤3000 nm*(ki/1.4 W/mK);

wherein ki is expressed in W/mK.
This provides an optimal insulation layer thickness.

In embodiments, the cooling fins (31) may have a depth (D) between 100 μm and 200 μm, allowing for efficient heat transfer to the cooling fluid. They may have a width from 10 μm to 100 μm, providing a good balance between heat transfer surface area and manufacturability. The fins (31) may be spaced apart by a distance of from 10 μm to 100 μm to allow for efficient flow of the cooling liquid between them.

The cover (60) may comprise an electrically non-conductive material to prevent electrical shorting of the device components. It may have a thermal conductivity lower than 0.5 W/m·K to minimize parasitic heat loss through the cover. Polydimethylsiloxane (PDMS) is an example of such a material, as it is easy to mold and bond to the substrate.

In embodiments, the device may be configured for sorting particles (e.g., biological cells). A second (i.e., main) fluidic channel allows the passage of biological cells, and the device may further comprise a third fluidic channel connected to each main fluidic channel, providing a pathway where the biological cells can be diverted. The device further comprises a bubble fluidic channel (the first fluidic channel) for providing bubble jets to the main fluidic channel. Each heater (20) is configured to generate localized heating within the bubble fluidic channel (50) to create vapor bubbles, diverting biological cells present in the main fluidic channel toward the third fluidic channels and enabling sorting. This allows the device to be used for high-throughput cell sorting.

Each heater (20) may be positioned laterally beside the first fluidic channel (50) or vertically beneath the first fluidic channel (50), providing efficient bubble generation for cell sorting. The microfluidic device (100) may further comprise a cell detection system configured to detect cells passing through the main fluidic channel, enabling timely activation of the heaters (20) for cell sorting. This allows for precise control over the sorting process.

The cell detection system may comprise optical detection components capable of identifying cells in the liquid flow of the main fluidic channel. Optical detection enables non-contact sensing of cells. The optical detection components may be selected from photodiodes, fluorescence detectors, or optical sensors—well-established optical detection technologies.

Additionally, the device may comprise a control unit configured to receive signals from the cell detection system and selectively activate the heating elements (21) of the heaters (20) to generate vapor bubbles that divert detected cells into the third fluidic channels. This provides automated control over the cell sorting process.

The monolithic substrate (10) may have a thickness (T) between 100 μm and 300 μm, with the proviso that this thickness (T) is larger than the depth (D) of the cooling fins (31). This provides mechanical stability while allowing room for the cooling fins (31).

In embodiments, the microfluidic device (100) may further comprise via openings (81) for forming electrical connections. These openings (81) may have a width larger than the width(S) of a trench between two cooling fins (31) and may cross the entire thickness of the monolithic substrate (10), allowing for convenient electrical interfacing to the device.

In embodiments, integrated optics may be formed in the monolithic substrate (10) for illumination and/or light collection, such as optical scatter light collection, enabling additional on-chip optical functionality.

In embodiments, for each cooling unit (30) and its associated heater (20), the planar area occupied by the cooling fins (31) in the cooling unit (30) may be between 80% and 120% of the planar area of the heating element (21) of the associated heater (20). The planar area occupied by the cooling fins (31) is measured as the area of the substrate surface taken up by the fins (31) when viewed perpendicular to the substrate surface, including both the area of the fin tops and the area between the fins (31). The planar area of the heating element (21) of the heater (20) is measured as the area of the heating element (21) when viewed perpendicular to the substrate surface. This ensures that the cooling capacity is well-matched to the heating power while minimizing the device footprint.

FIG. 3 shows a magnified cross-sectional view of the main components of the microfluidic device according to embodiments of the present disclosure. As illustrated in FIG. 3, the extremities (32) of the cooling fins (31) are separated by at most 100 μm from the heating elements (21). The thermal insulation layer (40) is disposed between the heaters (20) and the monolithic semiconductor substrate (10). The cover (60) is attached to the bottom of the substrate (10), enclosing the cooling fins (31) to form the cooling channels (61).

In a second embodiment, the present disclosure relates to a method of manufacturing a microfluidic device (100). The method comprises (i) providing a monolithic semiconductor substrate (10) having a thermal conductivity ks. A thermal insulation layer (40) is formed (ii) over a top surface of the substrate (10), where the thermal insulation layer (40) has a thermal conductivity ki at least 50 times smaller than the thermal conductivity ks of the monolithic substrate (10). One or more heaters (20) are formed (iii) over the thermal insulation layer (40), each heater (20) comprising a heating element (21). The bottom surface of the monolithic substrate (10) is etched (iv) to form a plurality of cooling fins (31) for one or more cooling units (30), each cooling fin (31) having an extremity (32) separated by at most 100 μm from one of the heating elements (21). A cover (60) is provided (v) and attached to the monolithic substrate (10) to close the liquid cooling units (30), thereby forming enclosed cooling channels (61) between the cover (60) and the substrate (10). The cover (60) includes one or more inlet ports (62) and one or more outlet ports (63) connected to the cooling channels (61) to allow circulation of a cooling liquid through them.

In embodiments, step (iii) of forming one or more heaters (20) over the thermal insulation layer (40), each heater comprising a heating element (21) may be followed by a step (iiib) of bonding the further semiconductor substrate over the heater. In embodiments, the further semiconductor substrate comprises at least one first fluidic channel (e.g., a bubble fluidic channel), and optionally comprises at least one second fluidic channel (e.g., a main fluidic channel) fluidically connected to the first fluidic channel. If it comprises at least a second fluidic channel, it may also comprise a third fluidic channel (e.g., for welcoming diverted particles) fluidically connect to the second fluidic channel.

In embodiments, step (iv) of etching the bottom surface of the substrate (10) may be performed in a single bottom etching step to simultaneously form:
a) the cooling fins (31); and
b) at least part of the fluidic via openings (51) for coupling with at least one first fluidic channel (50) (e.g., by the intermediary of a direct fluidic connection with a second (main) channel).

In embodiments, the method may include performing a single backside etching step to simultaneously form the cooling fins (31), via openings (81) for electrical connections, and at least part of fluidic via openings (51) for coupling with at least one first fluidic channel (50). The cooling fins (31) may be etched to a depth that leaves a portion of the substrate (10) unetched between the cooling fin trenches (33) and the thermal insulation layer (40). This is best visible in FIG. 3. The via openings (81) for electrical connections may have widths larger than the width (S) of trenches between cooling fins (31) and may be etched entirely through the substrate (10) to enable backside electrical connections. The fluidic via openings (51) may have widths similar to or smaller than the trenches (33) between the cooling fins (31) and may be etched to a depth that leaves a remaining unetched portion of the substrate (10) between the fluidic vias (51) and the thermal insulation layer (40).

In embodiments, the method may comprise performing a partial etching from both sides of the substrate (10). After the initial backside etching (ivb) that partially forms the fluidic vias (51), a partial front-side etching (ivc) step may be performed to remove the unetched substrate portion above the fluidic vias (51). This addresses aspect ratio limitations when creating narrow, deep features such as fluidic vias (51). This allows the fluidic vias (51) to be fully opened without increasing their footprint, enabling the use of small-diameter fluidic vias (51) advantageous for high-density device integration while maintaining structural integrity and manufacturability.

In embodiments, the manufacturing method may involve integrating electrical connections, fluidic interconnections, and cooling structures by forming their respective vias (51) and fins (31) in a single backside etching process, eventually followed by a front side etch to completely open the fluidic via openings. This approach enhances manufacturing efficiency and supports a compact device design suitable for high-density heater integration.

The cooling fins (31) may be separated by trenches (33) having a width between 10 μm and 100 μm, allowing for efficient flow of the cooling liquid between the fins (31). The fins (31) may have a width between 10 μm and 100 μm, providing a balance between heat transfer surface area and manufacturability.

The monolithic substrate (10) may be thinned (iva) to a thickness between 100 μm and 300 μm prior to the etching step (ivb), reducing the amount of etching needed to form the cooling fins (31). The cooling fins (31) may be etched (ivb) to a depth between 100 μm and 200 μm, allowing for efficient heat transfer to the cooling fluid.

In embodiments, the method may further comprise integrating optics in the monolithic substrate (10) for illumination and/or optical scatter light collection and/or optical fluorescence light collection, enabling on-chip optical analysis.

Additionally, the method may involve attaching (vi) a further semiconductor substrate (11) over the top surface of the heater (20) and forming (vii) at least one first (e.g., bubble) fluidic channel (50) in the further semiconductor substrate (11) and optionally at least one second (main) fluidically connected with the first and at least one third fluidic channel fluidically connected with the second. Each first fluidic channel is thermally coupled to at least one heater (20) so that the heater (20) can locally heat the contents of the first fluidic channel, e.g., allowing for producing a flow of bubbles from the bubble fluidic channel toward the main fluidic channel and thereby diverting cells toward the third fluidic channel.

The first fluidic channel (50) and optional second and third fluidic channels may be closed (viii) by attaching a transparent substrate (90) on top of the further semiconductor substrate (11), allowing for optical access to the channel. In embodiments, optical components may be integrated on both the transparent substrate (90) and the monolithic substrate (10), enhancing the optical detection capabilities of the device. The integrated optics in the transparent substrate (90) may be used for illumination, while those in the monolithic substrate (10) may be used for light collection such as scatter light collection and fluorescence detection.

### Example 1: Fabrication and Testing of a Microfluidic Cooling System for Cell Sorting

The aim of this experiment was to fabricate and test a microfluidic device with integrated cooling fins and heaters for high-throughput cell sorting applications. The device utilized localized heating to generate microbubbles for cell sorting actuation and efficient cooling to maintain stable sorting performance.

The cell sorting device according to the first embodiment was fabricated according to the second embodiment.

A monolithic silicon substrate with a thermal conductivity of 148 W/mK was used as the base substrate. A 1200 nm thick silicon dioxide layer was deposited on the top surface of the substrate to serve as a thermal insulation layer between the substrate and the heaters. The silicon dioxide layer had a thermal conductivity of 1.4 W/mK, which was significantly lower than that of the silicon substrate.

A heater was fabricated on the silicon dioxide layer using standard photolithography and metal deposition techniques. The heater consisted of a resistive heating layer made of W (W, Ti, TiN, and combinations thereof were options here) with dimensions of 100 μm×100 μm, a 50 nm SiN layer thereon, a 250 nm SiC layer thereon, a 110 nm Ta layer thereon, and a 30 nm AlOx layer thereon.

The bottom surface of the silicon substrate was first thinned down to 200 μm, then etched using deep reactive ion etching (DRIE) to form cooling fins. The etching process was carefully controlled to create fins with a depth of 150 μm, a width of 20 μm, and a spacing of 20 μm between adjacent fins. The extremity of each cooling fin was separated from the corresponding heating element by a distance (d) of about 50 μm.

A polydimethylsiloxane (PDMS) cover was fabricated using soft lithography techniques. The cover included inlet and outlet ports for the circulation of cooling liquid through the cooling channels formed by the fins. The PDMS cover was bonded to the bottom of the silicon substrate to seal the cooling channels.

Fluidic via openings for coupling with the first fluidic channel (e.g., by the intermediary of the main cell sorting channel) were simultaneously etched during the DRIE process used to create the cooling fins. The fluidic via openings had a smaller width compared to the cooling fin trenches and were not etched completely through the substrate. A second etching step was performed from the top side of the substrate to open the fluidic vias and connect them to the main fluidic channel, thereby coupling them to the first fluidic channel.

The main fluidic channel, bubble fluidic channel, a third fluidic channel were fabricated in a separate silicon substrate, which was bonded to the top of the heaters and cooling fins by the intermediate of a SiO₂ layer covering the heaters. The main fluidic channel, the bubble fluidic channel, and the third fluidic channel had a height of 35 μm and were formed through the separate silicon substrate and the intermediate SiO₂ layer so as to be adjacent to the heater for efficient thermal coupling.

A transparent quartz substrate with a thickness of 725 μm was bonded to the top of the fluidic channel substrate to provide optical access for cell detection and sorting verification.

The fabricated microfluidic device was connected to a control system enabling the circulation of a cooling liquid (deionized water) through the cooling channels at a flow rate of 10 mL/min. The heater was also connected to the control system enabling electrical activation of the heater using electrical pulses with a duration of 10 μs and a power of 100 mW.

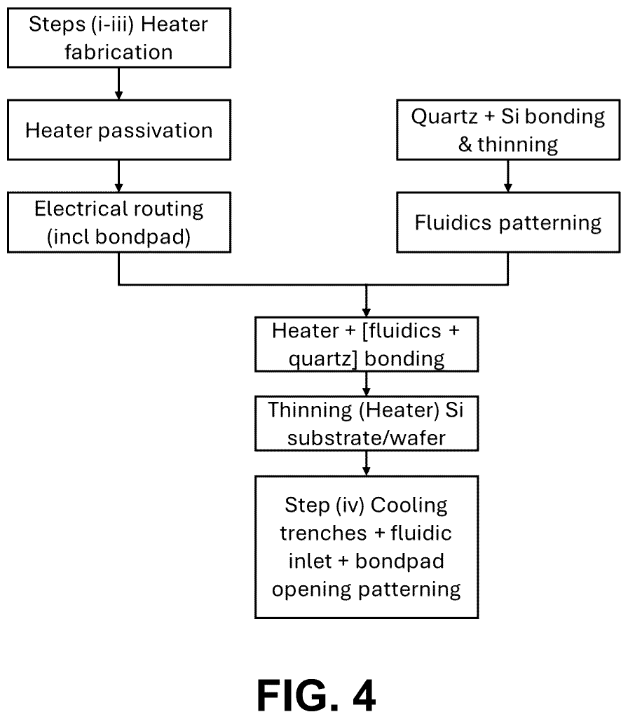

### Example 2 (FIG. 4): Alternative Fabrication of a Microfluidic Cooling System for Cell Sorting

The cell sorting device according to the first embodiment was fabricated according to the second embodiment.

A monolithic silicon substrate with a thermal conductivity of 148 W/mK was used as the base substrate. A 1200 nm thick silicon dioxide layer was deposited on the top surface of the substrate to serve as a thermal insulation layer between the substrate and the heaters. The silicon dioxide layer had a thermal conductivity of 1.4 W/mK, which was significantly lower than that of the silicon substrate.

A heater was fabricated on the silicon dioxide layer using standard photolithography and metal deposition techniques. The heater consisted of a resistive heating layer made of W (W, Ti, TiN, and combinations thereof were options here) with dimensions of 100 μm×100 μm, a 50 nm SiN layer thereon, a 250 nm SiC layer thereon, a 110 nm Ta layer thereon, and a 30 nm AlOx layer thereon.

A transparent quartz substrate with a thickness of 725 μm was bonded to the top of a separate silicon substrate for the fluidic channels to provide optical access for cell detection and sorting verification.

The main fluidic channel, bubble fluidic channel, and third fluidic channel, were fabricated and patterned in the separate silicon substrate. The fluidic channels had a height of 35 μm and were formed through the separate silicon substrate and the intermediate SiO₂ layer so as to be adjacent to the heater for efficient thermal coupling.

The bonded separate silicon substrate, comprising the fluidic channels, was bonded to the top of the heaters.

The bottom surface of the silicon substrate was then thinned down to 200 μm, then etched using deep reactive ion etching (DRIE) to form cooling fins. The etching process was carefully controlled to create fins with a depth of 150 μm, a width of 20 μm, and a spacing of 20 μm between adjacent fins. The extremity of each cooling fin was separated from the corresponding heating element by a distance (d) of about 50 μm.

A polydimethylsiloxane (PDMS) cover was fabricated using soft lithography techniques. The cover included inlet and outlet ports for the circulation of cooling liquid through the cooling channels formed by the fins. The PDMS cover was bonded to the bottom of the silicon substrate to seal the cooling channels.

Fluidic via openings for the main cell sorting channel were simultaneously etched during the DRIE process used to create the cooling fins. The fluidic via openings had a smaller width compared to the cooling fin trenches and were not etched completely through the substrate. A second etching step was performed from the top side of the substrate to open the fluidic vias and connect them to the main fluidic channel.

The fabricated microfluidic device was connected to a control system enabling the circulation of a cooling liquid (deionized water) through the cooling channels at a flow rate of 10 mL/min. The heater was also connected to the control system enabling electrical activation of the heater using electrical pulses with a duration of 10 μs and a power of 100 mW.

### Example 3: Multi-Channel Parallel Sorting Device

A microfluidic device is fabricated according to the second aspect with 16 parallel main channels and their corresponding bubble fluidic channels and third channels, each bubble fluidic channel equipped with its own heater and cooling unit. The monolithic silicon substrate has a thickness of 200 μm. Cooling fins are etched to a depth of 150 μm, leaving a 50 μm silicon layer between the fin extremities and the heaters. The cooling fins have a width of 15 μm and are spaced 15 μm apart. A 800 nm thick SiO₂ thermal insulation layer is deposited between the substrate and heaters.

The fluidic channels are 40 μm high. The main fluidic channel is 100 μm wide. Integrated waveguides for fluorescence excitation are fabricated in the 500 μm thick glass cover. Photodiodes for fluorescence detection are integrated into the silicon substrate.

### Example 4: Temperature-Controlled Microreactor Array

A microfluidic device according to the first aspect is fabricated according to the second aspect. Additionally, an array of 64 individually temperature-controlled microreactors, is fabricated so that each microreactor has a first fluidic channel thermally coupled to a heater. Each microreactor has a volume of 5 nL and is coupled to a heater and cooling unit. The cooling fins are 180 μm deep, 25 μm wide, and spaced 25 μm apart. A 2000 nm SiO₂ layer provides thermal insulation.

The device enables precise temperature control between 4 °C and 95 °C for each microreactor, with temperature stability of ±0.1 °C. This allows for parallel optimization of enzymatic reactions, PCR amplification, and protein crystallization conditions. The cooling system maintains stable temperatures even when adjacent reactors are operated at significantly different temperatures.

### Example 5: Cell Lysis and Analysis Device

A microfluidic device for rapid cell lysis and analysis is fabricated according to the second aspect. The device includes 32 parallel first channels, each with a thermal lysis region followed by a cooling region for rapid temperature cycling. Cooling fins in the lysis region are 160 μm deep, while those in the cooling region are 140 μm deep. Fin width and spacing are 20 μm in both regions. A 1500 nm SiO₂ layer provides thermal insulation.

The device achieves rapid thermal cycling between 95 °C for lysis and 4 °C for subsequent enzymatic reactions. Each first channel processes up to 1000 cells per second. Integrated impedance sensors and fluorescence detectors enable real-time analysis of cell contents. The cooling system allows for precise temperature control and rapid thermal transitions, enabling high-throughput single-cell analysis.

### Example 6: Microfluidic PCR Device with Gradient Thermal Zones

A microfluidic PCR device with 24 parallel reaction channels is fabricated according to the second aspect. Each first fluidic channel features three distinct thermal zones for denaturation, annealing, and extension steps. Cooling fins in each zone are optimized for different temperature ranges. Denaturation zone fins are 170 μm deep, annealing zone fins are 130 μm deep, and extension zone fins are 150 μm deep. All fins are 22 μm wide with 22 μm spacing. A 1200 nm SiO₂ thermal insulation layer is used.

The device maintains stable temperature gradients across the three zones (95 °C, 55-65 °C, and 72 °C) in all channels simultaneously. This allows for parallel optimization of PCR conditions for different targets. The cooling system enables rapid temperature transitions between zones, allowing for completion of 40 PCR cycles in less than 20 minutes while processing up to 10,000 template molecules per first fluidic channel.

Alternatively, the device utilizes a single thermal zone with integrated rapid temperature cycling capabilities. This configuration takes advantage of the substrate's low thermal mass and minimal thermal resistance to achieve swift temperature transitions. The unified zone incorporates uniform cooling fins (150 μm deep, 22 μm wide, 22 μm spacing) optimized for rapid heat transfer across the entire temperature range, an integrated water cooling system directly within the substrate, and enhanced thermal control elements for precise temperature cycling between denaturation (95 °C), annealing (55-65 °C), and extension (72 °C) phases. The single-zone design achieves temperature transition rates exceeding those of the three-zone configuration, completing 40 PCR cycles in approximately 15 minutes. This approach simplifies device fabrication while maintaining the ability to process up to 10,000 template molecules per channel, with the added benefit of reduced overall device footprint and improved thermal uniformity across all 24 parallel channels.

It is to be understood that although disclosed embodiments, specific constructions and configurations, as well as materials, have been discussed herein for devices according to the present disclosure, various changes or modifications in form and detail may be made without departing from the scope of this invention. For example, any formulas given above are merely representative of procedures that may be used. Functionality may be added or deleted from the block diagrams and operations may be interchanged among functional blocks. Steps may be added or deleted to methods described within the scope of the present disclosure.

What is claimed is:

1. A microfluidic device comprising:
a monolithic semiconductor substrate having a thermal conductivity ks;
one or more heaters disposed over a top surface of the monolithic semiconductor substrate, each heater comprising a heating element;
a thermal insulation layer disposed between the one or more heaters and the substrate, wherein the thermal insulation layer has a thermal conductivity ki at least 50 times smaller than the thermal conductivity ks of the monolithic substrate;
one or more liquid cooling units, each liquid cooling unit comprising a plurality of cooling fins formed in a bottom surface of the monolithic semiconductor substrate, each cooling fin having an extremity separated by a distance of at most 100 μm from one of the heating elements; and
a cover attached to the bottom of the monolithic semiconductor substrate and closing the one or more liquid cooling units, wherein:
a) the cover is configured to cover the cooling fins, thereby forming enclosed cooling channels between the cover and the monolithic semiconductor substrate; and
b) the cover includes one or more inlet ports and one or more outlet ports connected to the cooling channels to allow circulation of a cooling liquid through the cooling channels.

2. The microfluidic device according to claim 1, further comprising:
a further semiconductor substrate attached over the monolithic semiconductor substrate; and
at least one first fluidic channel formed in the further semiconductor substrate, each first fluidic channel being thermally coupled to at least one heater so that the heater is capable of locally heating the content of the first fluidic channel.

3. The microfluidic device according to claim 2, wherein the device is configured for sorting biological cells, wherein the device further comprises at least one second fluidic channel for allowing the passage of the biological cells, the second fluidic channel being fluidically connected to the first fluidic channel, wherein the device further comprises at least one third fluidic channel fluidically connected to the second fluidic channel, thereby providing a pathway where the biological cells can be diverted, wherein each heater is configured to generate localized heating within one of said first fluidic channels so as to create vapor bubbles for diverting the biological cells present in the second fluidic channel toward the third fluidic channels, thereby enabling said sorting.

4. The microfluidic device according to claim 2, further comprising a transparent substrate on top of the further semiconductor substrate and closing the first fluidic channel.

5. The microfluidic device according to claim 2, wherein the substrate comprises silicon.

6. The microfluidic device according to claim 1, wherein the thermal insulation layer comprises silicon dioxide.

7. The microfluidic device according to claim 1, wherein the thickness t of the thermal insulation layer satisfies the equation:
200 nm*(ki/1.4 W/mK)≤t≤3000 nm*(ki/1.4 W/mK);
wherein ki is expressed in W/mK.

8. The microfluidic device according to claim 1, wherein the cooling fins have a depth (D) between 100 μm and 200 μm.

9. The microfluidic device according to claim 1, wherein the monolithic substrate has a thickness (T) between 100 μm and 300 μm with the proviso that said thickness (T) is larger than the depth (D) of the cooling fins.

10. The microfluidic device according to claim 1, further comprising via openings for forming electrical connections, said openings having a width larger than the width(S) of a trench between two cooling fins, crossing the entire thickness of the monolithic substrate.

11. The microfluidic device according to claim 1, wherein the substrate comprises silicon.

12. The microfluidic device according to claim 11, wherein the thermal insulation layer comprises silicon dioxide.

13. The microfluidic device according to claim 12, wherein the thickness t of the thermal insulation layer satisfies the equation:
200 nm*(ki/1.4 W/mK)≤t≤3000 nm*(ki/1.4 W/mK);
wherein ki is expressed in W/mK.

14. The microfluidic device according to claim 13, wherein the cooling fins have a depth (D) between 100 μm and 200 μm.

15. A method of manufacturing a microfluidic device, the method comprising:
(i) providing a monolithic semiconductor substrate having a thermal conductivity ks;
(ii) forming a thermal insulation layer over a top surface of the substrate, wherein the thermal insulation layer has a thermal conductivity ki at least 50 times smaller than the thermal conductivity ks of the monolithic substrate;
(iii) forming one or more heaters over the thermal insulation layer, each heater comprising a heating element;
(iv) etching a bottom surface of the monolithic substrate to form a plurality of cooling fins for one or more cooling units, each cooling fin having an extremity separated by a distance of at most 100 μm from one of the heating elements; and
(v) providing a cover attached to the monolithic substrate so as to close the one or more liquid cooling units, thereby forming enclosed cooling channels between the cover and the substrate wherein the cover includes one or more inlet ports and one or more outlet ports connected to the cooling channels to allow circulation of a cooling liquid through the cooling channels.

16. The method according to claim 15, wherein the cooling fins are etched to a depth that leaves a portion of the substrate unetched between the cooling fin trenches and the thermal insulation layer.

17. The method according to claim 15, wherein step (iv) of etching the bottom surface of the substrate comprises a single bottom etching step (ivb) to simultaneously form:
a) the cooling fins; and
b) at least part of the fluidic via openings for coupling with at least one first fluidic channel.

18. The method according to claim 17, wherein the single bottom etching step (ivb) is a dry etching step that:
a) in addition to forming cooling fins separated by trenches of width (W) by etching to a depth that leaves a portion of the substrate unetched, also
b) simultaneously forms via openings for electrical connections, said via openings having a width larger than W, by etching entirely through the bottom surface of the substrate.

19. The method according to claim 18, wherein the fluidic via openings are etched during the single bottom etching step (ivb) to a depth that leaves a portion of the substrate unetched between each fluidic via opening and the thermal insulation layer, and wherein the method further comprises removing (ivc) said portion by etching it from the top surface of the monolithic substrate.

20. The method according to claim 19, wherein the fluidic via openings are etched during the single bottom etching step (ivb) to a depth that leaves a portion of the substrate unetched between each fluidic via opening and the thermal insulation layer, and wherein the method further comprises removing (ivc) said portion by etching it from the top surface of the monolithic substrate.
